(19) United States
(12) Patent Application Publication
(10) Pub. No.: US 2009/0232471 A1
(43) Pub. Date: Sep. 17, 2009

(54) Information Recording Apparatus

(75) Inventors: Hironori KOMI, Tokyo (JP); Keisuke INATA, Ebina (JP); Daisuke YOSHIDA, Yokohama (JP); Yusuke YATABE, Yokohama (JP); Mitsuhiro OKADA, Yokohama (JP); Tomoyuki NONAKA, Chigasaki (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 12/366,978

(22) Filed: Feb. 6, 2009

(30) Foreign Application Priority Data
Mar. 12, 2008 (JP) 2008-062003

(51) Int. Cl. H04N 5/93; G10L 21/00

(52) U.S. Cl. 386/52; 704/275; 704/E15.001

(57) ABSTRACT

An information recording/reproducing apparatus capable of simplifying settings of a scene breakpoint includes a voice recognition unit and a control unit. At a timing when the voice recognition unit extracts a feature during recording, the control units sets a scene breakpoint and generates a thumbnail at the same time. During reproduction, the thumbnail and voices when the feature was extracted are output at the same time.

### INCORPORATION BY REFERENCE

The present application claims priority from Japanese application JP 2008-062003 filed on Mar. 12, 2008, the content of which is hereby incorporated by reference into this application.

### BACKGROUND OF THE INVENTION

The present invention relates to an information recording apparatus for recording information representative of images and voices.

The following inventions are disclosed as techniques for controlling an image recording or reproducing apparatus by voice recognition.

For example, JP-A-2006-121155 (Patent Document 1) describes a video cassette recorder which is “constructed to record a second VISS (VHS Index Search System) signal having a duty ratio different from that of a first VISS signal to be recorded on a control track at the start of video recording and set a versing-up (cue) of the video tape to the position where the second VISS signal is recorded, in response to a predetermined operation” “to thereby provide the video cassette recorder capable of set a versing-up (cue) of the video tape to the position of interruption, after the video image was interrupted”.

JP-A-2003-298916 (Patent Document 2) describes an imaging apparatus in which “a voice recognition unit 110 recognizes voices representative of operation commands from voices to be recorded, and deletes voice data corresponding to the voices recognized as operation commands or applies sound volume reduction processing” “to thereby provide a video camera or the like capable of accepting voice instructions, suppressing the voice instructions from being recorded, and reducing troubles in hearing during reproduction”.

JP-A-2003-230094 (Patent Document 3) describes “a problem associated with manually forming chapters” is “a large work of creating detailed chapters because a person gives proper breakpoints in accordance with the contents, although there is no problem of precision” (paragraph [0008]). It describes, as the invention capable of solving this problem and the like, a chapter creating apparatus which “classifies a text obtained by applying speech recognition to the received multimedia data through the use of linguistic intelligence, and automatically creates a chapter linked to the original multimedia data”.

### SUMMARY OF THE INVENTION

An imaging apparatus such as a video camera and a video recorder has often a function of creating a thumbnail image at the start of each video recording and displaying a thumbnail list when the video images are to be reproduced. In many cases, as one of thumbnails is selected from the list, the record content corresponding to the selected thumbnail is reproduced. There is an apparatus having a function of adding/deleting a thumbnail when a user edits the unit (chapter) representative of scene breakpoints at an arbitrary position.

However, a user feels cumbersome in instructing a scene breakpoint relative to the content during recording/reproducing at a timing other than the recording start, and this point is to be improved from the viewpoint of usability. For example, when a user desires to form a scene breakpoint during photographing with a video camera, the user depresses a button to stop/start recording at each breakpoint. In this case, discontinuous scenes are appreciated thereafter being intercepted at the breakpoint. A similar problem occurs when a voice recorder is used and a breakpoint is desired to be added at each agenda during a conference.

Further, even if a thumbnail of a photographed chapter is displayed, there is a case in which a user cannot know the photographed object if the user views only the thumbnail image. It is therefore desired that a photographer supplies each chapter with information for identifying the contents of each chapter.

To this end, a character title may be input by using buttons or the like. However, this work of adding a title to each partitioned chapter by using buttons or the like in parallel to photographing with the imaging apparatus may become a load upon the user. On the other hand, it may be considered that a title is added to each chapter after a series of recording is completed. However, it may take time and work for a user to remember the photographed subjects.

According to the invention described in Patent Document 1, although a breakpoint position can be added to a video image, it does not describe that a user adds information on the video image recorded for each breakpoint.

According to the invention described in Patent Document 2, although an operation command can be input using voices, it does not investigate partitioning chapters and addition of information for identifying partitioned scenes by a user.

Patent Document 3 describes that text information obtained through speech recognition is partitioned into proper units in accordance with a subject matter or the like. However, there are cases in which a unit obtained by partitioning text information is different from that intended by a user, or the content of text information representative of the content of each unit is different from that intended by a user. Further, it does not describe a method of improving usability when a user adds information for identifying each breakpoint.

It is an object of the present invention to provide an information recording apparatus for recording information by partitioning the information into predetermined chapters in which information recorded by a user can be easily identified.

The above-described issue can be solved by the inventions recited in claims. For example, an information recording/reproducing apparatus includes a voice recognition unit and a control unit. At a timing when the voice recognition unit extracts a feature during recording, the control units sets a scene breakpoint and sets a thumbnail at the same time. During reproduction, the thumbnail and voices when the feature was extracted are output at the same time. In this manner, the information recording apparatus sets a breakpoint of video images by using input voice information.

According to the present invention, it becomes possible to provide an information recording apparatus for recording information by partitioning the information into predetermined chapters in which information recorded by a user can be easily identified.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram of a first embodiment.

FIG. 2 is a diagram explaining scene breakpoints of the first embodiment.

FIG. 3 is a diagram illustrating a correspondence between scene breakpoints and stream times of the first embodiment.

FIG. 4 is a diagram illustrating a thumbnail list of the first embodiment.

FIG. 5 is a diagram illustrating a thumbnail list and GUI of the first embodiment.

FIG. 6 is a diagram illustrating a thumbnail list and GUI of another example of the first embodiment.

FIG. 7 is a diagram illustrating an LCD screen for scene breakpoints of the first embodiment.

FIG. 8 is a block diagram of a second embodiment.

FIG. 9 is a diagram explaining scene breakpoints.

FIG. 10 is a diagram illustrating the structure of an apparatus according to a third embodiment.

FIG. 11 is a flow chart illustrating an example of processes of the third embodiment.

### DESCRIPTION OF THE EMBODIMENTS

Embodiments of the present invention will now be described.

### First Embodiment

An information recording apparatus is an apparatus for recording information, such as an HDD camcorder and a BD recorder. However, the information recording apparatus is not limited only to these apparatus. The invention is applicable also to a mobile phone, a PDA and the like having a function of recording information. Examples of information include video images and voices.

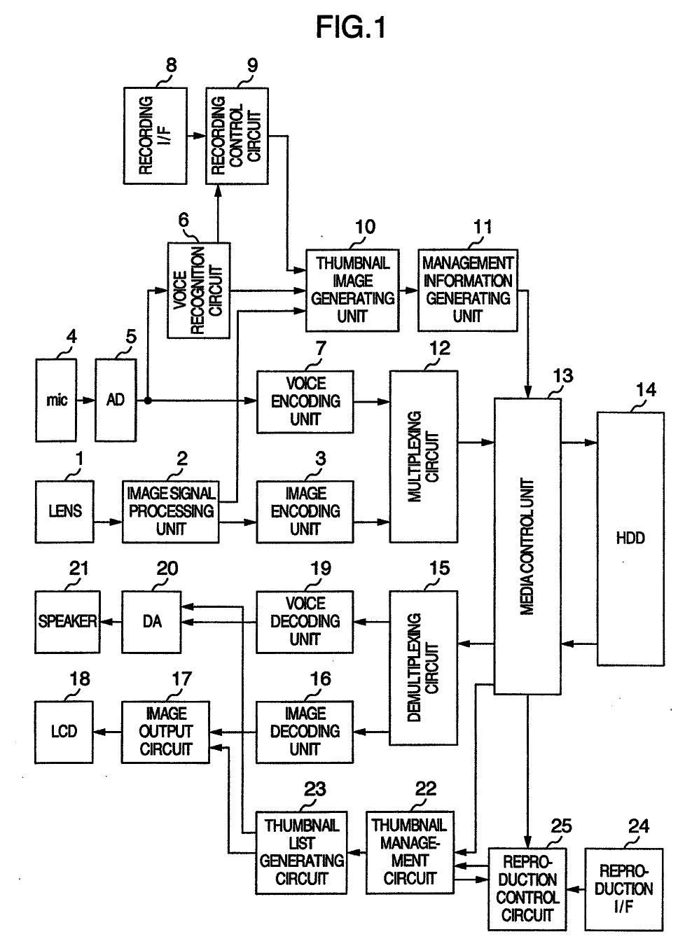

FIG. 1 is a block diagram illustrating the structure of the first embodiment. The embodiment will now be described with reference to FIG. 1. In this embodiment, the block diagram illustrates the structure of a hard disc drive (HDD) camcorder for recording/reproducing video images and voices in/from an HDD. FIG. 1 illustrates a lens 1, an image signal processing unit 2, an image encoding unit 3, a microphone 4, an analog/digital (AD) converter circuit 5, a voice recognition circuit 6, a voice encoding unit 7, a recording interface 8, a recording control circuit 9, a thumbnail image generating unit 10, a management information generating unit 11, a multiplexing circuit 12, a media control unit 13, an HDD 14, a demultiplexing circuit 15, an image decoding unit 16, an image output circuit 17, a liquid crystal display (LCD) 18, a voice decoding unit 19, a digital/analog (DA) converter circuit 20, a speaker 21, a thumbnail management circuit 22, a thumbnail list generating circuit 23, a reproduction interface 24 and a reproduction control circuit 25.

An image input from the lens 1 is converted into a video signal by a photosensor (not shown) such as a CMOS and a CCD. This video signal is scanned along a scan line direction and converted into digital data by the image signal processing unit 2. It is herein assumed that thirty frames per sec of a standard image size of 720 horizontal pixels×480 vertical pixels are generated. The converted digital data is transferred to the image encoding unit 3. The image signal processing unit 2 and image encoding unit 3 are structured as a dedicated circuit such as ASIC.

It is assumed that the recording interface unit 8 is made of, for example, a button for instructing a recording start/stop and the like and that a recording start/stop signals are input, by a toggle process through button depression, to the recording control circuit 9 which controls the entirety of the apparatus.

The recording control circuit unit 9 is made of, for example, a microprocessor and the like, and connected by CPU address/data buses (not shown) to control each block of the entirety of the apparatus.

In the following, description will be made on the operation of outputting a recording start instruction from the recording control circuit 9 to each block in response to a status change to a recording start status through button depression.

The digital video data transferred to the image encoding unit 3 is output, as a video bit stream compression-encoded, for example, in conformity with the MPEG2 (ISO/IEC13818-2) specification or the like, to the multiplexing block 12.

Voices are input from the microphone 4 as analog signals which are converted by the AD conversion circuit 5 into digital signals. For example, stereophonic voice signals sampled at a frequency of 48 KHz are output from the AD conversion circuit 5 as PCM voice signals subjected to 16-bit quantization of L and R channels.

The processed data is input to the voice recognition circuit 6 and transferred to the voice encoding unit 7. The processed data is output, as a voice bit stream in conformity with the compression specification MPEG2 Layer II (ISO/IEC13813-3) or the like, from the voice encoding unit 7. The voice recognition circuit 6 and voice encoding unit 7 are structured as a dedicated circuit such as ASIC.

The image/voice streams input to the multiplexing circuit 12 are packet-multiplexed into a transport stream in conformity with the MPEG2 system specification (ISO/IEC13818-1) or the like, and the transport stream together with packet multiplexing information is transferred to the media control unit 13.

In this case, a time stamp is affixed to the header field added during packet multiplexing, to judge the timing of recorded scenes in the stored data. During reproduction to be described later, the voices and video images can be correctly synchronized through comparison of time stamps, and it is possible to always recognize a correspondence between an image position and a voice position.

The packet multiplexed data trains are transferred from the multiplexing circuit 12 to the media control unit 13, and recorded in HDD 14 as a file. In this case, the recording control block 9 has a function of generating management information for managing the address (e.g., sector number) of HDD at which the file is stored, and recording the management information in HDD 14 via the medial control unit 13. Further, the management information data is generated in such a manner that by making the file independent or by recording an address of a file breakpoint position in the management information, at each recording start and end, the management information is read later from HDD 14 to identify a desired recording start position, and the packet multiplexed stream can be read from the identified position and reproduced. In addition to HDD 14 for hard discs, devices for storing information such as an SD and a flash memory may be used to constitute the apparatus of the embodiment.

Next, description will be made on a procedure of generating a breakpoint and a thumbnail by using voices during recording.

PCM voice data output from the AD converter circuit 5 is also input to the voice recognition circuit 6 during recording.

The voice recognition circuit 6 is provided with a function of, when a feature is detected in accordance with preset feature patterns, outputting information on a detection time. The term “feature pattern” used herein is a feature pattern of voices, for example, for a scene breakpoint instruction.

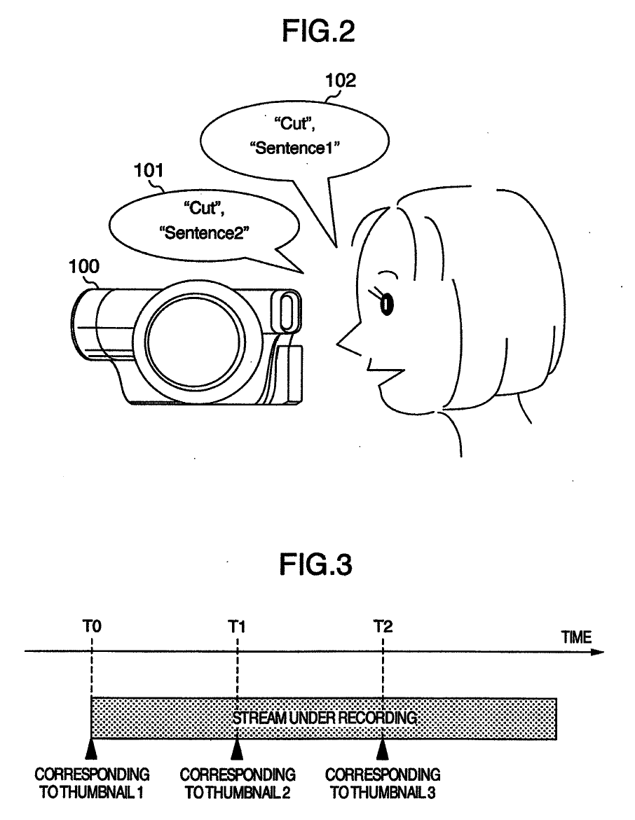

The voice recognition circuit 6 can be structured by using approaches presently used for voice recognition. For example, the voice recognition circuit extracts a predetermined feature amount from input PCM voice data. The voice recognition circuit 6 performs pattern matching between the extracted feature amount and a prepared feature amount of voice data, or performs comparison between threshold values and a peak and a peak time of a voice level. If the comparison result indicates that PCM voice data satisfies a predetermined condition, it is judged that a feature is detected, and detection time information is reported. For example, as illustrated in FIG. 2, it is assumed that a speaker delivers utterances 101 and 102 while photographing with a camera 100. The first utterance is “CUT followed by an arbitrary utterance “SENTENCE1”. Next, after a lapse of some period, the second utterance “CUT” is delivered being following by an arbitrary utterance “SENTENCE2”. In this case, if “CUT” is registered beforehand in the voice recognition circuit 6 as a feature pattern, the voice recognition circuit 6 transfers a feature extraction time to the thumbnail image generating unit 10.

In pattern matching, if a feature amount of input PCM voice data is identical or similar to voice data prepared in advance, a corresponding process is executed. For example, the voice data among the voice data prepared in advance most analogous to input PCM voice data may be selected as consistent data. After a feature amount is detected in the information recording apparatus, the feature amount may be transmitted to an external apparatus (not shown) such as a server, and the external apparatus performs pattern matching. In this case, it is assumed that the information recording apparatus has a communication interface (not shown) for wireless or wired communications. The voice data stored in advance includes acoustic model of each phoneme constituting voice, a dictionary storing each significant word, and the like.

The voice recognition circuit 6 may store in advance voice patterns of a photographer in a memory (not shown). The voice recognition circuit 6 may recognize only voices of a user whose voice patterns are registered. In this case, it is possible to suppress, for example, a possibility that a breakpoint is generated and “SENTENCE1” and the like are recorded, by sounds entered from a photographed object or an utterance of a person other than the photographer, as opposed to the intention of the photographing user. Voice data of a plurality of persons may be stored in a memory (not shown) as voice data prepared in advance. In this case, a photographer is authenticated at the startup, and the voice data of the authenticated photographer is set as the comparison target.

Next, with reference to FIG. 3, description will be made on the relation among a stream under recording, the utterances 101 and 102 and stream times under recording. It is assumed that recording a present scene starts at time T0, a feature of the utterance 101 “CUT” is extracted at time T1, and a feature of the utterance 102 “CUT” is extracted at time T2. Position information corresponding to times T0, T1 and T2 of the stream under recording from the media control unit 13 is recognized by the recording control circuit 9 as a recording start time, a scene breakpoint 1, a scene breakpoint 2, respectively. Address information of the stream corresponding to the times in HDD is recorded in the management information.

In the embodiment, although the position of the breakpoint 1 or the like is managed by time, the embodiment is not always limited to only the time. For example, it is needless to say that the information recording apparatus of the embodiment can be realized even if information is used which is representative of a relative position in the whole video image data, such as a number and an address assigned to each frame constituting video images.

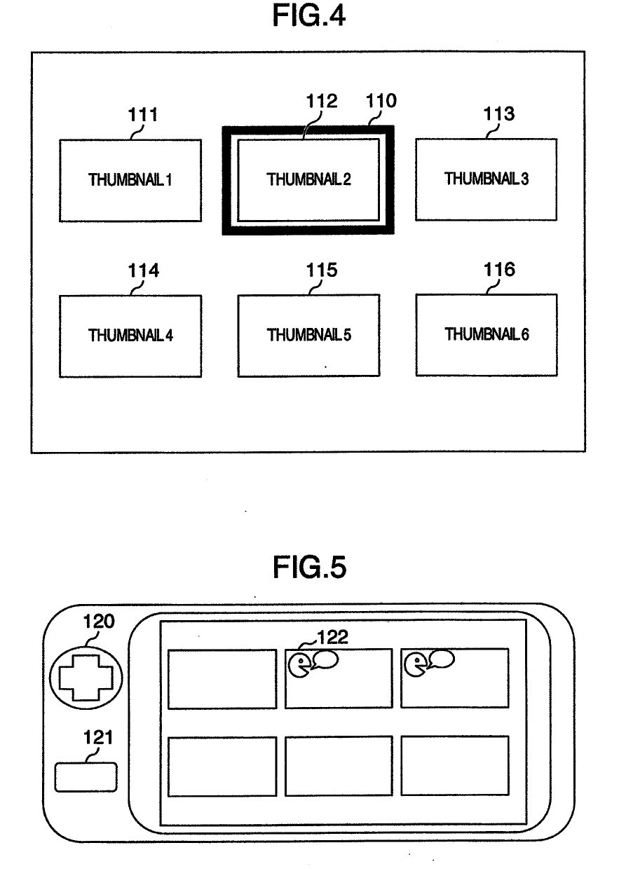

Next, description will be made on a procedure of generating thumbnails corresponding to T0, T1 and T2. At T0, T1 and T2, images corresponding to the times are transferred from the image signal processing unit 2 to the thumbnail image generating unit 10. The thumbnail image generating unit 10 processes the image in a size easy to be displayed as a thumbnail image. For example, if six images are output to the apparatus having an output size illustrated in FIG. 4, a frame which reduces pixel sizes by ⅙ or more in the horizontal direction and by ½ or more in the vertical direction is generated to form basic data of a thumbnail image.

This data may be compressed, for example, by JPEG, or by MPEG or the like to form a moving image thumbnail of a short period. The thumbnail data processed in the manner described above is converted by the management information generating unit 11 into thumbnail management information correlated to the scene breakpoint and to the corresponding stream address, to be recorded in HDD 14 via the media control unit 13.

The voice recognition circuit 6 may record the voice information on “SENTENCE1” in the utterance 101 and “SENTENCE2” in the utterance 102 followed by the feature detection patterns “CUT”, as voice data of a preset period, and may store the voice information in the management information in correspondence with the information on corresponding thumbnails 2 and 3. In this case, when thumbnails are reproduced later, the voice data can be reproduced at the same time when the thumbnails are displayed. To this end, each sentence immediately after the feature detection pattern is also recorded in the thumbnail management information via the thumbnail image generating unit 10, in correspondence with each thumbnail.

With this recording process, “SENTENCE1” in the utterance 101 and “SENTENCE2” in the utterance 102 can be stored as a so-called voice title representative of the summary of each scene.

With the method described above, a photographing user is not required to depress sequentially the recording start/stop button at each scene breakpoint and to intercept recording. Since there is no cumbersome button operations, a user can instruct a scene breakpoint at an intended timing while concentrating upon tracking an object and zooming an object, providing the advantages of improving usability.

In the example described above, the camera 100 operates to correlate voices input in a predetermined period after voice information representative of a partitioned scene is input, to the partitioned scene. Instead, the camera 100 may operate to correlate voice information input in a predetermined period before voice information representative of a partitioned scene is input, to the partitioned scene. In this case, a user utilizes the camera 100 by delivering an utterance “CUT” after delivering an utterance “SENTENCE1”.

The reproduction interface 24 is a user interface for reproduction operations. For example, the reproduction interface 24 is constituted of an operation device such as bottons for receiving user operations and a notifying device such as a display for notifying a user of an apparatus status. LCD 18 may be used also as the notifying device.

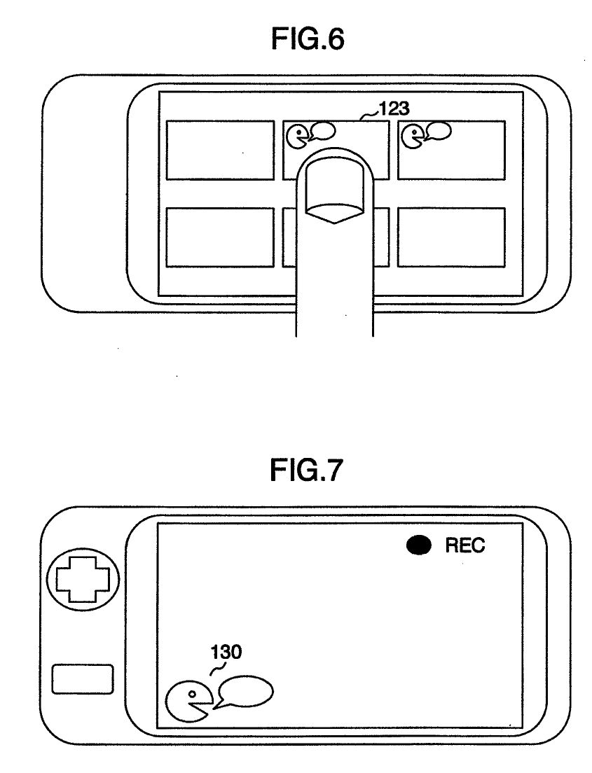

Next, description will be made on a procedure of reproducing recorded video images/voices starting from a thumbnail list screen. When data recorded in HDD 14 is reproduced, a thumbnail list screen display button on the reproduction interface 24 is depressed to transfer an instruction signal for entering a thumbnail list display mode to the reproduction control circuit 25. For example, a button 121 illustrated in FIG. 5 and mounted on a camera housing may be used, or the thumbnail list screen may be displayed automatically after power on.

Upon reception of the instruction of transferring to the thumbnail list display mode, the reproduction control circuit 25 reads the management information from HDD 14 via the medial control unit 13 to confirm the file structure, and thereafter instructs the thumbnail management circuit 22 to read the thumbnail management information and the management information from HDD 14. The thumbnail management circuit 22 reads the thumbnail management information from HDD via the media control unit 13 to sequentially read, e.g., in the order of recording, thumbnail data at the recording start time, and thumbnail data corresponding to each scene breakpoint designated by voices, and transmits the read thumbnail data to the thumbnail list generating circuit 23 as illustrated in FIG. 4. The thumbnail list generating circuit 23 executes a process necessary for displaying the thumbnail list. For example, if the thumbnail data was subjected to compression encoding, the thumbnail data is expanded at this stage.

On the thumbnail list screen, the thumbnail list generating circuit 23 OSD-displays graphics indicating a selection position on a thumbnail of a present selection candidate, as indicated at 110 in FIG. 4. The graphics 110 indicating the selection position are, for example, a cursor, a focus or the like. For the selection position, as an up, down, right or left direction is designated by a direction key 120 in FIG. 5, a direction instruction signal is transmitted from the reproduction interface block 24 to the reproduction control circuit 25 to change a corresponding thumbnail position and notifies this position to the thumbnail management circuit 22. In response to this, the thumbnail management circuit 22 reads again thumbnail management information on a corresponding thumbnail group from HDD 14.

If the selection candidate is outside the presently displayed page, thumbnail management information is read in order to generate a new page. A corresponding selection candidate position is updated, and the thumbnail list generating circuit 23 moves the graphics representative of the selection position. At the same time, voice data corresponding to the selection position is read, processed, e.g., expanded to a format capable of outputting voices, and transferred to the DA converter circuit 20. Lastly, voices are output from the speaker 21, with the thumbnail image list screen being displayed.

For example, in recording sports, very similar images are disposed side by side in some cases, and it may become difficult to find a desired scene at once. With the function described above, voice data is output at the same time, providing the advantageous effects of simple guidance of each scene. It is therefore easy to select a scene. Photographing can be made by becoming conscious of the layout of a thumbnail list, particularly immediately after a feature sound for a scene breakpoint uttered by a speaker during recording. It is therefore possible to identify a desired scene breakpoint and obtain a thumbnail list more quickly than editing a chapter later as in the case of a conventional recording/reproducing apparatus.

As described above, as a reproduction start button is depressed at a selection position of each scene displayed in the thumbnail list, data of a corresponding scene is reproduced. This reproduction procedure will be described below.

As a user instructs a reproduction start, the reproduction interface circuit 24 instructs a reproduction start to the reproduction control circuit 25. The reproduction control circuit acquires a present selection position of a thumbnail from the thumbnail management circuit 22, and instructs a reproduction from the position corresponding to the thumbnail to each block to start reproduction. In reproducing, a stream from the position corresponding to the thumbnail is read from HDD 14 via the media control unit 13 to the demultiplexing circuit 15. The demultiplexing circuit 15 demultiplexes multiplexed packet, and transmits video image and voice encoded streams to the image decoding unit 16 and voice decoding unit 19, respectively. An expansion process in conformity with the compression specifications is executed. A video signal output from the image decoding unit 16 is processed by the image output circuit 17 to convert the video signal into a format capable of being output to a display such as LCD. The video signal is displayed on LCD 18 or the like to be output to an external. PCM voices are output from the voice decoding unit 19, converted into analog voices by the DA converter circuit 20 and output from the speaker 21 to an external. Although LCD 18 is used as an example of a display of the embodiment, the embodiment is not limited to LCD. For example, it is needless to say that an organic EL and other displays may also be used.

In the embodiment, although the compression/expansion process for video images and voices in conformity with the MPEG specification, the multiplexing/demultiplexing process, a recording process for HDD in conformity with the DVD specifications and the like have been described, it is apparent that the object of the information recording apparatus of the embodiment is realized even if other compression techniques such as MPEG1, MPEG4, JPEG, H.264 are used, with similar effects of the invention. Similar effects can also be obtained even if an optical disc, a nonvolatile memory device or a tape device is used as the recording medium. Further, it is apparent that the structure intended by the information recording apparatus of the embodiment is realized even if a recording method performs data management for scene breakpoints and different data train times without incorporating compression.

In the embodiment described above, although the recording/reproducing apparatus for video images and voices is illustratively used, for example, the embodiment may be applied to a voice recorder. The voice recorder is provided with an equivalent voice recognition circuit and performs data management for identifying a scene breakpoint. In later reproduction, it is possible to reproduce efficiently from a desired breakpoint. In this case, it is possible to skip to the next chapter only by button operations without using thumbnails. A chapter number may be input directly by a number input key.

It is possible to add an icon 122 illustrated in FIG. 5 to a thumbnail in order to distinguish between a thumbnail with a chapter breakpoint by voices and a thumbnail at the recording start. The thumbnail list generating circuit 23 controls whether an icon is added to the thumbnail, by distinguishing the scene breakpoint by voices in accordance with the thumbnail management information.

By adding an icon, a user can recognize that voices are added to the breakpoint.

As illustrated in FIG. 6, if a thumbnail selection screen is a touch panel, the reproduction control circuit 25 is structured in such a manner that a selection state enters when a thumbnail is depressed once, and voices corresponding to a desired thumbnail are output. Further, when reproduction is started from a selected thumbnail, the stream is reproduced from a corresponding position when the thumbnail is touched twice.

FIG. 7 illustrates an LCD image during recording. An icon 130 in FIG. 7 is an interface for explicitly notifying a user of that the voice recognition circuit 6 extracts a feature during recording and a scene breakpoint is generated. A pulse signal is generated at a timing when the voice recognition circuit 6 extracts a feature, and the icon 130 is OSD-superposed, for example, for about 10 seconds after the pulse is received. A user can therefore confirm whether the scene breakpoint is generated at a timing intended by the user.

### Second Embodiment

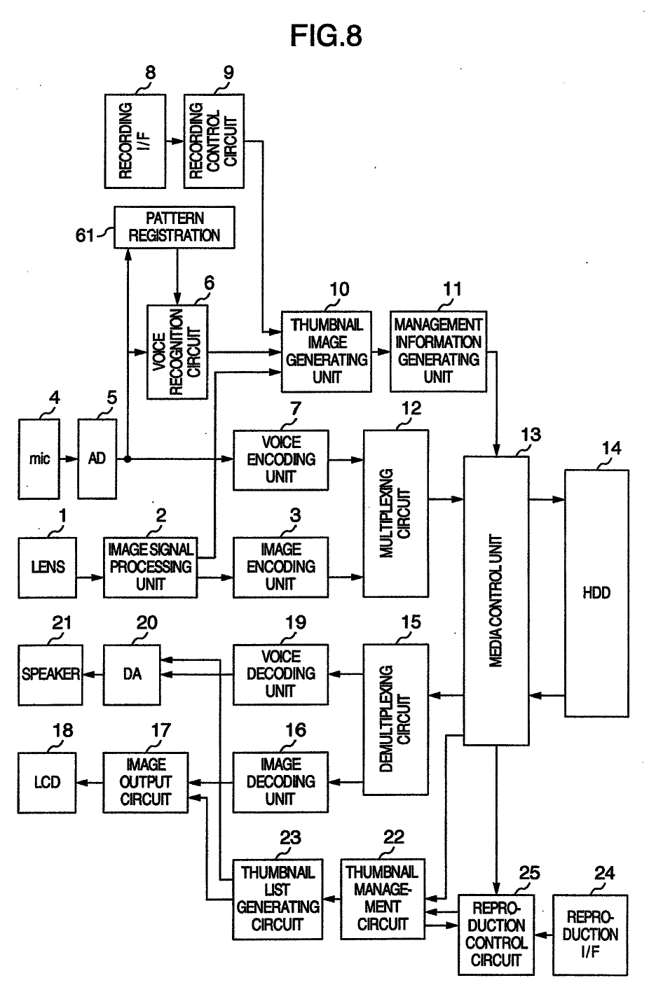

FIG. 8 illustrates the second embodiment.

In the first embodiment, the feature used for voice recognition is set beforehand. In the second embodiment, as illustrated in FIG. 8, a pattern registration circuit 61 for voice recognition is disposed at the succeeding stage of the AD converter circuit 5. As a pattern register mode setting button on the recording interface 8 is depressed, the pattern register circuit 61 records voice data during a predetermined period. The voice data may be recorded, for example, in a nonvolatile memory to hold the data even after power off. In recording later, the data recorded in the pattern register is used as reference data of pattern matching for feature detection. A plurality of patterns may be registered so that the voice recognition circuit 6 can detect a plurality of features at the same time.

By using the function described above, it becomes possible to control a scene breakpoint more flexibly.

Next, description will be made on another example of the procedure of generating a scene breakpoint by voices during recording and generating a thumbnail.

It is assumed for example that as illustrated in FIG. 9, a speaker photographing with a camera 100 delivers utterances 141 and 143. The first utterance 141 us “CUT” to be followed thereafter by an arbitrary utterance “Title” and “SENTENCE3”. Next, after a lapse of some period, the second utterance “CUT” follows. In this case, voice information on the utterance “SENTENCE3” is stored in correspondence with a chapter delimited by two utterances 141 and 143 “CUT”. In this manner, a correspondence between the chapter and voices can be confirmed at an arbitrary time of each breakpoint. Also in this case, although the utterance 142 “SENTENCE3” is not correlated to the first breakpoint time, “SENTENCE3” may be generated when the thumbnail of this breakpoint is selected. In this manner, a pattern of voices representative of an instruction of adding a so-called voice title can be set as the feature pattern like the utterance “Title”.

### Third Embodiment

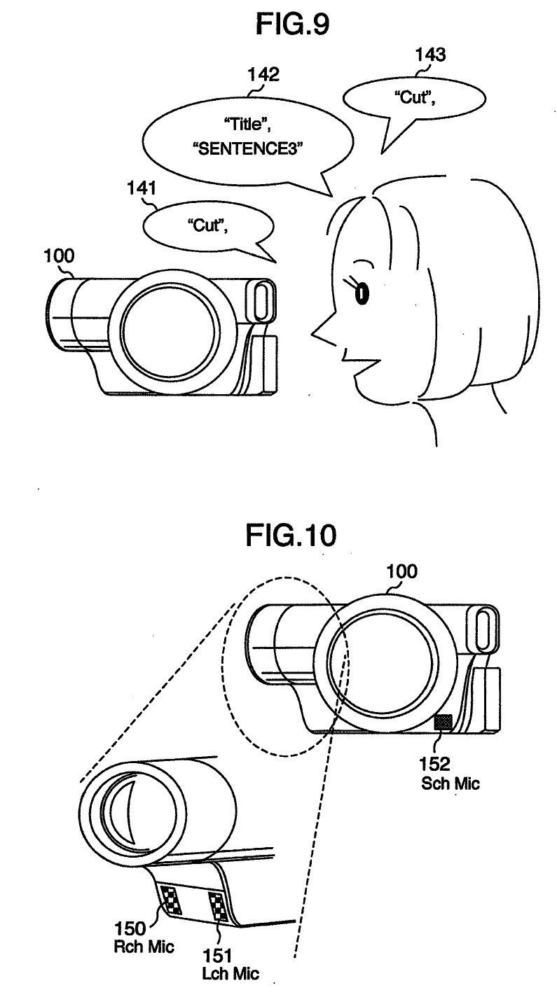

FIG. 10 illustrates a camera of the third embodiment. The camera 100 illustrated in FIG. 10 has the same structure as that of the first and second embodiments, and has an R-channel microphone 150, an L-channel microphone 151 and a Sub-channel microphone 152 in place of the microphone 4. The Sub-channel microphone 152 collects mainly an utterance of a photographer. To this end, the Sub-channel microphone 152 when held is mounted on the plane opposite to the lens 1.

Voices recorded with the R-channel microphone 150, L-channel microphone 151 and Sub-channel microphone 152 are called R-channel voices, L-channel voices and S-channel (Sub-channel) voices, respectively.

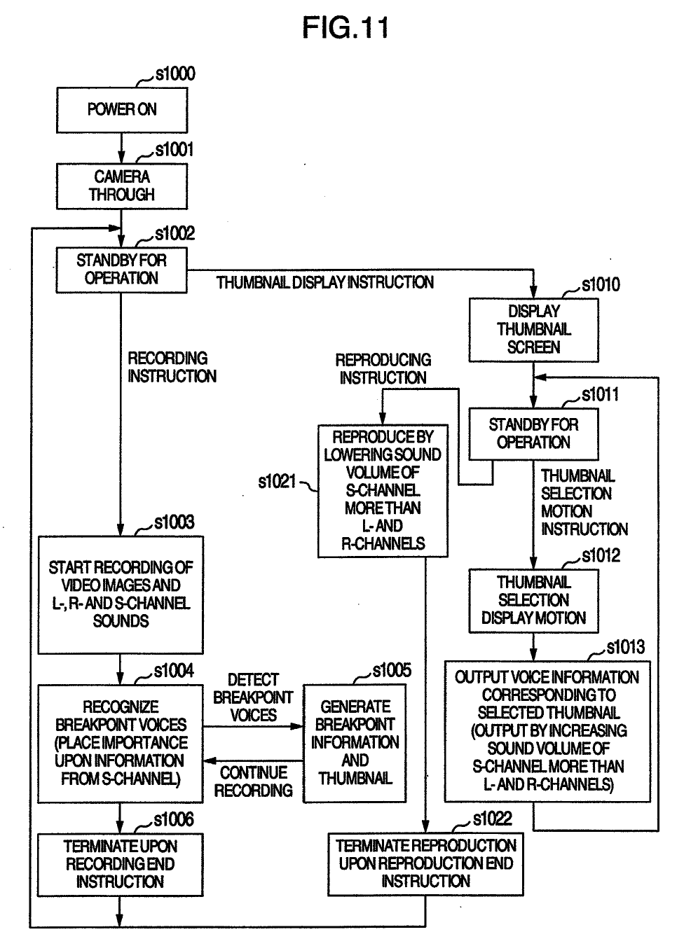

FIG. 11 illustrates a flow chart representing the operation of the camera of the embodiment.

As a power is turned on at s1000, the operation starts in a camera through mode (s1001), and a user instruction is waited (s1002). Upon reception of a user instruction, the camera 100 performs either recording or thumbnail list display.

As a recording instruction is give at s1002, recording starts for video image information and voices of three channels, L-, R- and S-channels (s1003). Next, the voice recognition circuit 6 performs voice recognition of input voices (s1004). The camera 100 executes a process such as setting a scene breakpoint similar to the first end second embodiments (s1005). However, at s1004 voice recognition is performed placing importance upon information on the S-channel voices input from the Sub-channel microphone 152. In this manner, an instruction of the photographer by voices can be recognized more precisely. At s1004, for example, only the S-channel voices may be used for voice recognition.

Next, if the user gives a recording end instruction, the camera 100 terminates the recording process (s1006).

Upon reception of an instruction of displaying a thumbnail list at s1002, the camera 100 displays a thumbnail list (s1010).

The camera 100 waits for a user instruction (s1011), either to execute a thumbnail selection motion or to reproduce scenes representative of the selected thumbnail image.

Upon reception of a selection motion instruction for a thumbnail at s1010, the camera 100 displays again thumbnails on LCD 18 in the state that the selection display 110 in FIG. 4 is moved (s1012). Next, the camera 100 outputs voices corresponding to the scene of the thumbnail focused due to motion of the selection display 110 (s1013). At s1013, the camera 100 reproduces voices by increasing the sound volume of S-channel voices more than the sound volumes of L- and R-channel voices. By outputting S-channel voices by increasing its sound volume, the camera 100 can make the user recognize the content more correctly.

At s1013, voices may be output by increasing the gain of the S-channel. At this step, S-channel voices may be output by cutting R- and L-channel voices.

If an instruction of reproducing one scene is issued at s1011, the camera 100 reproduces the instructed scene (s1021). At s1021 the sound volume of S-channel voices is lowered more than those of L- and R-channel voices. S-channel voices my be output by increasing the gains of L- and R-channels. S-channel voices may be cut at s1021. By using the voice recognition information, only the breakpoint voices of the S-channel may be output by lowering the sound volume. Only the voices corresponding to the breakpoint may be superposed upon opposite phase components to eliminate these voices.

When the user issues a reproduction end instruction, the camera 100 terminates the reproduction process (s1022).

In the state that the thumbnails are displayed, a user can grasp the content of each scene by voices. On the other hand, while each scene is reproduced, a sound volume for reproducing “SENTENCE1” or the like is lowered. It is therefore possible to suppress a possibility that voices entered the Sub-channel microphone 152 from a photographer are felt noisy by a user. The process of this embodiment is effective particularly for the case in which the mouth of a photographer using the camera 100 becomes near the Sub-channel microphone 152.

In the operation of the embodiment, although the camera 100 processes voices collected by the Sub-channel microphone 152 as the voices of the photographer, the embodiment is not limited thereto. For example, without using the Sub-channel microphone 152, the camera 100 may increase the sound volume of voices corresponding to the thumbnail if the selection display 110 is moved on the thumbnail list display, whereas the sound volume is lowered if a reproduction instruction is issued.

In the operation described above, a ratio between the sound volume of S-channel voices and the sound volumes of L- and R-channel voices is changed at s1013 and s1021. The operation of the camera 100 is not limited thereto. For example, the camera 100 may change a ratio between the sound volume of S-channel voices at s1013 and the sound volume of S-channel voices at s1021.

Only the sound volume of the Sub-channel microphone may be changed by a volume control button (not shown) in accordance with a user preference. A plurality of reproduction modes with preset sound volumes of the Sub-channel voices may be preset. In this case, the reproduction mode is switched by a button operation or the like to control the voice level of a photographer in accordance with a user necessity. The reproduction mode may be a mode of displaying thumbnails, a mode of reproducing one scene, a mode of outputting video image information and voice information to an external apparatus via connectors (not shown), and other modes.

As described above, the camera 100 of the embodiment can control only the voices for a scene breakpoint instruction in accordance with an importance degree during reproduction, and is very effective for improving usability.

The configuration of the present invention is not limited to the above-described embodiments, but may be changed as desired without departing from the scope of the invention. For example, without using the Sub-channel, a plurality of microphones may be used to generate voices of a speaker in a particular direction by utilizing directivities of the microphones, and the generated voices are used for the voices from the Sub-channel. The content of each embodiment may be combined.

It should be further understood by those skilled in the art that although the foregoing description has been made on embodiments of the invention, the invention is not limited thereto, and various changed and modifications may be made without departing from the spirit of the invention and the scope of the appended claims.

1. An information recording apparatus comprising:
a recording unit which records information;
a voice inputting unit which inputs voice information;
a voice recognizing unit which recognizes said input voice information; and
a controller which generates, if said voice recognizing unit recognizes that said input voice information is representative of a scene breakpoint instruction, information representative of a position of said scene breakpoint, and correlates breakpoint voice information which is voice information input in a predetermined period before or after the voice information representative of the scene breakpoint instruction is input, to the position of said scene breakpoint.

2. The information recording apparatus according to claim 1, further comprising:
a reproducing unit which reproduces said information from a position of said scene breakpoint designated by a user operation.

3. The information recording apparatus according to claim 1, wherein:
said information recorded by said recording unit is video image information; and
the information recording apparatus further comprises a generating unit which generates a thumbnail corresponding to a position of said scene breakpoint.

4. The information recording apparatus according to claim 3, further comprising:
a displaying unit which displays said thumbnail;
an operating unit which selects one of thumbnails displayed on said displaying unit by a user operation; and
a reproducing unit which reproduces said video image information from a position corresponding to said selected thumbnail.

5. The information recording apparatus according to claim 4, further comprising:
a voice outputting unit which outputs voice information, wherein:
said controller correlates a thumbnail corresponding to a position of said scene breakpoint to said breakpoint voice information corresponding to the position of said scene breakpoint; and
said voice outputting unit outputs, when said thumbnail is to be displayed, the breakpoint voice information correlated to said thumbnail.

6. The information recording apparatus according to claim 4, wherein said thumbnail displaying unit displays an identification indication for discriminating between a thumbnail corresponding to said scene breakpoint delimited by said voice recognizing unit and a scene breakpoint at a recording start time.

7. The information recording apparatus according to claim 1, further comprising:
a storing unit which stores a feature amount of a sample sound, wherein:
said voice recognizing unit compares the feature amount of said input voice information with the feature amount of a sample sound to recognize whether said input voice information is representative of the scene breakpoint instruction; and
the sample sound stored in said storing unit can be changed.

8. The information recording apparatus according to claim 1, further comprising:
a storing means which stores a feature amount of voice of each user, wherein:
if said input voice information is voices of a user whose feature amount is stored in said storing unit and if it is recognized that said input voice information is representative of the scene breakpoint instruction, said controller generates information representative of the position of said scene breakpoint, and correlates said breakpoint voice information to the position of said scene breakpoint.

9. An information recording apparatus comprising:
a recording unit which records video image information;
a voice inputting unit which inputs voice information;
a voice recognizing unit which recognizes said input voice information;
a controller which controls, if it is recognized that said input voice information is representative of a scene breakpoint instruction, to form a position of said scene breakpoint;
a generating unit which generates a thumbnail corresponding to the position of said scene breakpoint;
a displaying unit which displays said thumbnail; and
an operating unit which selects one of thumbnails displayed on said displaying unit by a user operation, wherein:
said thumbnail displaying unit displays an identification indication for discriminating between a thumbnail corresponding to said scene breakpoint delimited by said voice recognizing unit and a scene breakpoint at a recording start time.

10. An information recording apparatus comprising:
a recording unit which records video image information;
a reproducing unit which reproduces said video image information;
a voice inputting unit which inputs voice information;
a voice recognizing unit which recognizes said input voice information;
a controller unit which generates, if said voice recognizing unit recognizes that said input voice information is representative of a scene breakpoint instruction, information representative of a position of said scene breakpoint, and correlates breakpoint voice information which is voice information input in a predetermined period before or after the voice information representative of the scene breakpoint instruction is input, to the position of said scene breakpoint;
a generating unit which generates a thumbnail corresponding to the position of said scene breakpoint; and
a displaying unit which displays a plurality of generated thumbnails, wherein:
said controller controls to reproduce said breakpoint voice information at a first sound volume if said plurality of thumbnails are displayed, and
to reproduce said breakpoint voice information at a second sound volume if said video image information is reproduced by said reproducing unit.

11. An information recording apparatus comprising:
a recording unit which records video image information;
a voice inputting unit which inputs voice information;
a reproducing unit which reproduces said video image information and said voice information;
a voice recognizing unit which recognizes said input voice information; and
a controller unit which generates, if said voice recognizing unit recognizes that said input voice information is representative of a scene breakpoint instruction, information representative of a position of said scene breakpoint, and correlates breakpoint voice information which is voice information input in a predetermined period after the voice information representative of the scene breakpoint instruction is input, to the position of said scene breakpoint, wherein:
said reproducing unit includes a plurality of reproduction modes, and controls an output level of said breakpoint voice information in accordance with each reproduction mode.
